(19) United States
(12) Patent Application Publication
(10) Pub. No.: US 2025/0022019 A1
(43) Pub. Date: Jan. 16, 2025

(54) SYSTEM AND METHOD FOR NETWORK ENTITY RANKINGS AND EXCHANGES

(71) Applicant: Wells Fargo Bank, N.A., San Francisco, CA (US)

(72) Inventors: Alan W. Hecht, San Francisco, CA (US); Julio Jiron, San Bruno, CA (US); Darius A. Miranda, San Francisco, CA (US); Dennis E. Montenegro, Concord, CA (US); Traci H. Nguyen, San Francisco, CA (US); Darrell Lee Suen, San Ramon, CA (US)

(21) Appl. No.: 18/351,085

(22) Filed: Jul. 12, 2023

(51) Int. Cl. G06Q 30/0282; G06Q 20/08

(52) U.S. Cl. CPC G06Q 30/0282; G06Q 20/085

(57) ABSTRACT

A system receives a selection, by a first entity, of product, provided by a second entity, wherein the first entity and the second entity are members of an entity network. The system receives an indication of receipt of the product via an application programming interface (API), transmitted by a first entity, and derives a first ranking metric for the second entity of the entity network based on feedback received from the first entity of the entity network. The system derives a second ranking metric for the second entity of the entity network based on one or more transactions received from a third entity of the entity network, determines whether the first ranking metric is valid based on the second ranking metric, and provides the first ranking metric to entities of the entity network based on the validity of the first ranking metric.

### TECHNICAL FIELD

The present disclosure generally relates to network entities, and more specifically to network entity rankings and exchanges.

### BACKGROUND

Certain entities, such as banks, small businesses, suppliers, and the like, participate as entities in one or more networks, such as business networks. For example, small businesses procure financial services from banks, purchase supplies provided by a variety of suppliers, and provide goods and services to the public. The various network entities exchange a variety of goods and services between each other.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 illustrates entity network and a network entity and exchange system, according to some embodiments.

FIG. 2 is a flowchart of an embodiment of process for providing goods and/or services between entities of and entity network, and for ranking the entity that provided the goods and/or services, according to some examples.

FIG. 3 is a flowchart of a process for creating and using entity networks, according to some examples.

FIG. 4 is a block diagram depicting a machine suitable for executing instructions via one or more processors, according to some embodiments.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as more efficiently exchanging and tracking goods and services among network entities, such as business network entities (e.g., suppliers, merchants, service provides, financial institutions, and so on). The technical problems solved also include verifying the validity of certain entity rankings, for example, automatically determining, via transactions that are received by a trusted party (e.g., a financial institution), that certain entity rankings are valid or not valid. Solving the technical problem of verifying the validity of the rankings also includes graph analysis of social networks.

In certain examples, each entity in a network is assigned one or more ranking metrics as goods and services are provided to the various network entities. The one or more ranking metrics include payment metrics (e.g., timely payment, complete payment), goods metrics (e.g., timely delivery of goods, complete delivery of goods, quality of goods being delivered), services metrics (e.g., timely delivery of services, quality of services delivered), ease of contracting for goods/services metrics, customer service metrics, and so on. In some examples, the ranking metrics are assigned by other entities during regular course of business. For example, a merchant entity receives supplies from a supplier entity. The merchant entity then ranks the supplier entity based on timeliness of delivery of the supplies, any discrepancies in between the order and the supplies delivered, customer service, and so on. Likewise, the supplier entity ranks the merchant entity based on timeliness of invoice payment, fulfillment of certain contractual terms (e.g., providing a delivery dock, having personnel ready to receive the supplies at an appointed time, and so on), customer service, and so on. As used herein, “product” refers to a good and/or a service.

Each entity in network accrues certain points or network “currency,” which can be used for monetization. For example, each entity collects points based on number of favorable ranking metric reviews submitted of fellow network entity members, timeliness of reviews, as well as based on a current ranking for the entity. In some examples, certain techniques, such as social graphs and anonymization, further described below, are used to minimize or eliminate “gamification” of rankings. That is, artificially inflating and deflating rankings can be prevented or minimized by using certain social network graph techniques.

Dynamic social networks can be created, which aggregate various network entities into a virtual company. The virtual company can then leverage its size and connections, for example, to issue wholesale transactions for goods and services. A network entity and exchange system is provided, that enables a practical application of the techniques described herein to build, manage and use dynamic entity networks throughout the networks' lifetimes. For example, the network entity and exchange system includes websites, applications (e.g., mobile device applications), graphical user interfaces (GUIs), and the like, to enable a network entity representative (e.g., merchant user) to interface with a variety of network entities in information and/or product exchanges, mentoring, creation of virtual companies, and building their entity's business.

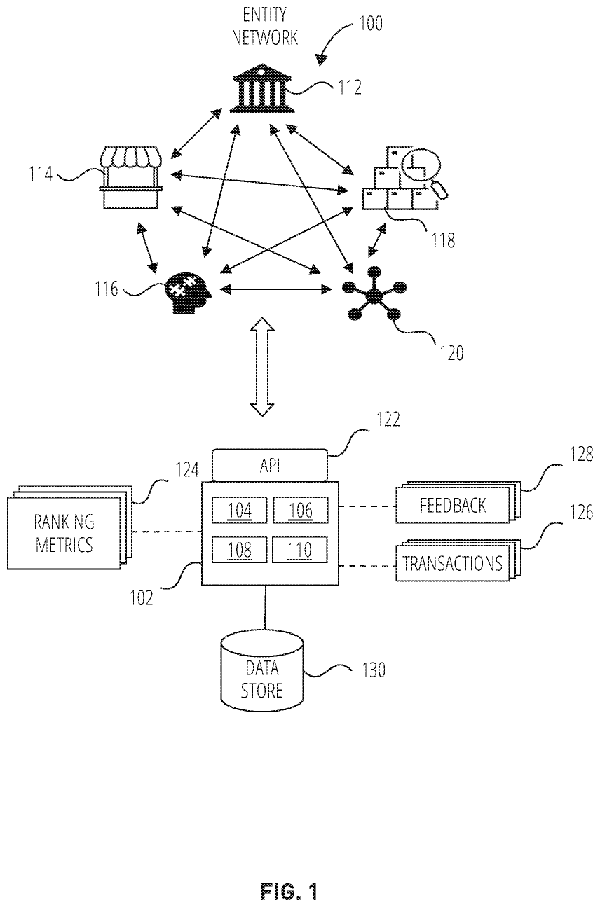

FIG. 1 illustrates an example entity network 100 and a network entity and exchange system 102, according to some embodiments. In the depicted example, the network entity and exchange system 102 includes a ranking and monetization system 104, a social networking and exchange system 106, a ranking verification system 108, and a mentoring system 110. The network entity and exchange system 102 can be used by various entities 112, 114, 116, 120, 118 to participate as members of the entity network 100. Various types of entities can be participants in the entity network 100 via the network entity and exchange system 102. For example, a financial entity 112 (e.g., retail and commercial bank, investment bank, brokerage firm, mortgage company, and so on) can participate by providing financial goods and/or services such as loans, investment products, checking and savings accounts, insurance products, and the like.

Other participant entities include merchant entities 114. The merchant entities 114 sell a variety of goods, including online goods, manage physical store location(s), and so on, and can include a variety of small business. Service provider entities 116 provide a variety of services, such as consulting services, contractor services, plumbing services, electrician services, software services, legal services, medical and health service providers, and so on. Participant entities can also include suppliers and/or supply chain entities 118, which supply a variety of goods including raw materials, manufactured parts, finished goods, and the like. In some cases, an entity of the entity network 100 can provide merchants goods, but additionally provide services, supplies, or a combination thereof. Also shown are grouped entities 120. In some examples, entities of a grouped entity 120 are combined as a virtual company, thus enabling economies of scale (e.g., wholesaler scales) that may not have been available to a single entity or a smaller set of entities.

Entities 112, 114, 116, 118, 120 can interact with the network entity and exchange system 102, for example, via an application programming interface (API) 122. In certain embodiments, the API 122 is accessed via API keys (e.g., public/private keys) used to provide authentication and security. The API 122 exposes a set of objects (e.g., classes, functions, callable code) to interface with and use the network entity and exchange system 102, including the ranking and monetization system 104, the social networking and exchange system 106, the ranking verification system 108, and the mentoring system 110. It is to be noted that the network entity and exchange system 102 and the API 122 can be provided by an entity, such as the financial entity 112, by a third-party (e.g., a party not a member of the entity network 100 such as a software-as-a-service (SaaS) cloud provider), or a combination thereof.

The ranking and monetization system 104 provides for the creation and editing of ranking metrics 124 for each entity in the entity network 100. The ranking metrics 124 include payment metrics, such as timely payment and complete payment metrics. The timely payment metric track a time between receiving an invoice and paying the invoice. Faster payments result in higher timely payment metric scores. A complete payment metric tracks how much of the payment was received, in cases where the invoice was paid only partially. For example, the invoice may have specified a payment of $1000 but the payment received was of $900. Receipt of partial payments results in lower complete payment metric scores.

For entities that manufacture and/or sell goods, goods metrics are provided, which include a timely delivery of goods metric, a complete delivery of goods metric, and a quality of goods being delivered metric. The timely delivery of goods metric measures how much time has elapsed between an agreed-upon delivery date (and in some cases, time), and an actual delivery date. On-time deliveries carry higher timely delivery of goods metric scores. The complete delivery of goods metric tracks to see if there were ordering mistakes. That is, orders that are received as incomplete (e.g., lacking an agreed-upon number of items and/or sending the wrong item(s)) receive lower complete delivery of goods metric scores. The quality of goods being delivered metric measures a difference between certain agreed-upon quality metrics (e.g., defect rate, agreed-upon weight, agreed-upon size, failure rate), agreed-upon certifications (e.g., Underwrites Laboratories (UL) certification, National Fire Protection Association (NFPA) certification, International Organization for Standardization (ISO) certifications, and so on), and the goods delivered. The more the goods delivered varies from the agreed-upon quality metrics and certifications the lower the quality of goods being delivered metric scores.

Ranking metrics 124 also include services metrics such as timely delivery of services metrics, quality of services delivered metrics, ease of contracting for goods/services metrics, customer service metrics, and so on. The timely delivery of services metrics measures how close the service provider entity 116 met an agreed-upon delivery date (and in some cases, delivery time) with a receipt date (and in some cases receipt time) of when the service was delivered. For example, and auditor service provider may agree to complete an audit by a certain date and time. The closer the service delivery date and time to the agreed-upon date and time the higher the timely delivery of services metric score. The quality of services delivered metric measures how well the service delivered compares against a median or an average of the same service. For example, a median security audit may include n number of errors in detecting a white hat test intrusion while the provided security audit detected n-1 number of errors. Improvements in the provided service over the median service result in higher quality of services delivered metric scores, while deficiencies in the provided service over the media service result in lower quality of services delivered metric scores.

Ease of contracting for goods/services metrics measure a time to signature(s), a number of changes to contract language, a use of standard contracts (e.g., uniform commercial code (UCC) contracts), and the like. Customer service metrics include average time in queue, average reply time, average first response time, time to issue resolution, and the like. The ranking metrics 124 also include metrics that measure environmental impact of goods/services, achievement of certain certifications (e.g., Leadership in Energy and Environmental Design (LEED), Energy Star, GreenGuard UL, and so on), environmental, social, and governance (ESG) metrics, diversity, equity, and inclusion (DEI) metrics, and the like.

The ranking and monetization system 104 receives as input transactions 126 and/or feedback 128 to output or otherwise derive values for the various ranking metrics 124. In certain examples, the transactions 126 are provided by the financial entity 112 and are representative of payment in exchange for goods and services between entities in the entity network 100. For example, the merchant entity 114 may pay the supplier entity 118 for delivery of certain goods. Transactions 126 can then include a debit transaction and debit timestamp from an account of the merchant entity 114 and a corresponding credit transaction and credit timestamp to an account of the supplier entity 118. In certain examples, the transactions are anonymized to comply with legal and/or regulatory requirements of one or more jurisdictions where the entity network 100 may operate. The transactions 126 can then be used to derive certain transaction-derived ranking metrics 124, such as the timely payment metric and the complete payment metric. Transactions 126 also include proof of goods and/or services delivered (e.g., manifests signed upon goods and/or services received) provided by the shipping and/or receiving entities. Shipping and receiving entities can also provide other proof of shipment and/or receipt, such as photographs/video of shipped and/or of received goods, useful in calculating transaction-derived timely delivery of services metrics and quality of services delivered metrics.

Feedback 128 includes assessments, reviews, comments, responses to surveys, and so on, shared for certain entities of the entity network 100. For example, the merchant entity 114 can provide feedback 128 for the supplier entity 118 after engaging in a supply transaction with the supplier entity 118. The feedback 128 can be public, semi-public, or private. Public feedback 128 is shared among all members of the entity network 100, semi-public feedback 128 is shared among a selected set of entities in the entity network 100, and private feedback 128 is shared only with parties participating in a transaction and with the network entity and exchange system 102. The feedback 128 is also used to derive the ranking metrics 124. For example, ratings values, such as ratings between 1-10, can be collected and used as user-derived ranking metrics 124 of an entity 112, 114, 116, 118, 120, in the entity network 100. Likewise, reviews, comments, assessments, and the like, can be used to create user-derived ranking metrics 124.

In some examples, the ranking metrics 124 result in monetization opportunities. That is, achieving certain rankings will accrue points or “currency” that can then be spent in a variety of ways. In some examples, when an entity receives a ranking metrics 124 over a certain value in a range of values (e.g., over 7 in a range of 1-10) and/or certain certifications (e.g., LEED, Energy Star, GreenGuard UL, and so on), certain number of points are added to a monetization account of the entity. The points can then be used to exchange goods and services between the entities of the entity network 100, for example, when using the ranking and monetization system 104 to purchase goods and/or services.

The social networking and exchange system 106 provides for the creation of the grouped entities 120 as well as for the linking of various external social networks. For example, a group of entities of the entity network 100 can decide to aggregate and form a grouped entity 120. The grouped entity 120 can then leverage its members for certain activities, such as wholesale buying and or selling of goods and services, obtaining lower financing rates, spreading out certain costs (e.g., marketing costs, legal costs, insurance costs, and so on), and leveraging expertise from members/employees of the grouped entity 120.

The social networking and exchange system 106 also acts an interface to the various social networks linked to the entities in the entity network 100. For example, the network entity and exchange system 102 can use the linked social networks to buy and sell products available via social network marketplaces, to create marketing campaigns that incorporate the social networks, as well as to extract social network data for analysis, as further described below. An entity in the entity network 100 can also open up its external social network and/or internal entity network, including membership in any grouped entities 120, to other entities in the entity network 100 and/or to external parties.

The ranking verification system 108 provides for techniques to minimize or eliminate “gaming” of rankings. That is, an attempt may be made to artificially inflate or to lower an entity's ranking. In certain examples, the ranking verification system 108 can use the transactions 126 as verification of correct rankings. The transactions 126, due to their verifiability and use for financial exchanges, provide for an inherent verification and validity, and can be compared to the user-derived ranking metrics 124. For example, the ranking verification system 108 can compare a transaction-derived ranking metric 124 with the corresponding user-derived ranking metric 124 and flag the user-derived ranking metric 124 if there is too large of a difference. The flagged user-derived ranking metrics 124 can then be set aside and not used, for example, until further verification occurs.

The ranking verification system 108 can also use the social networking and exchange system 106 for verifying rankings. For example, attempts may be made by friends or supporters of an entity A to lower the rankings of an entity B. The social networking and exchange system 106 can determine, via graph analysis, that a social network exists, related to entity A, and members of the social network are actively submitting ranking values lower (or higher when attempting to boost entity A's rankings) when compared to a median ranking value. For example, rankings lower and/or higher than a median value can be compared to see if they originate from users that have a first level (direct) connection to an entity, a second level connection to an entity, and so on, by using a social graph provided for by the social networking and exchange systems 106.

The mentoring system 110 is used to provide mentoring and support to the various entities 112, 114, 116, 118, 120, of the entity network 100. For example, experienced members of entities in the entity network 100 can participate as mentors, providing guidance growing a business, how improving customer service, gaining financial expertise, and so on. Experts, such as experts in business finance (e.g., chartered financial consultant (ChFC), certified financial planner (CFP), and so on), in supply chain management, in product rollouts, in manufacturing, and so on, can also participate as mentors. The mentoring system 110 provides a list of mentors, and a user, such as an owner of the entity 114, can then select one or more mentors that the user would like to collaborate with. In some examples, the mentors may be entities in the entity network 100, such as service provider entities 116. Accordingly, certain mentors can participate in the entity network 100 just as any other participant entity, including the user of ranking metrics 124, and the ability to create and/or join the grouped entities 120. Mentors may also be outside of the entity network 100, such as third-party service providers.

Mentoring services can be paid for by points, such as points received based on the ranking metrics 124, as well as through barters or exchanges. For example, the goods sold by the entity merchant entity 114 can be provided in lieu of payment for mentoring services. Indeed, entities in the network entity and exchange system 102 can exchange or otherwise barter any goods and services as well as use points (or real currency) received based on the ranking metrics 124. The values for the points used to buy certain goods and services can vary based on demand for the goods and services as well as based on the total supply of points.

A user member of an entity 112, 114, 116, 118, 120 can additionally create interrelationships by using drag-and-drop techniques. For example, the owner of the entity 114 may build a virtual supply chain by selecting one or more supplier entities 118 and can also create a connection between a first supplier entity 118 and a second supplier entity 118. The network entity and exchange system 102 can then automatically contact the first and second supplier entities 118 with any instructions provided by the merchant entity 114, such as instructions for the second supplier entity 118 to modify goods provided by the first supplier entity 118 to the second entity. The modified goods may then be incorporated into a shipment supplied to the merchant entity 114 by the second supplier entity 118. Likewise, a supplier entity 118 can drag-and-drop one or more merchant entities 114 that provide goods, drag-and-drop one or more service provider entities 116 (e.g., consultants) to help in configuring supply chains for certain goods, and so on.

The data store 130 is a database, such as a relational database, an object-oriented database, a cloud-based database, and the like, that is operatively coupled to the network entity and exchange system 102. The data store 130 stores information such as the transactions 126, the feedback 128, the ranking metrics 124, social media information, mentoring information, and so on. In some examples, the data store 130 is encrypted and the data anonymized to increase security of the network entity and exchange system 102.

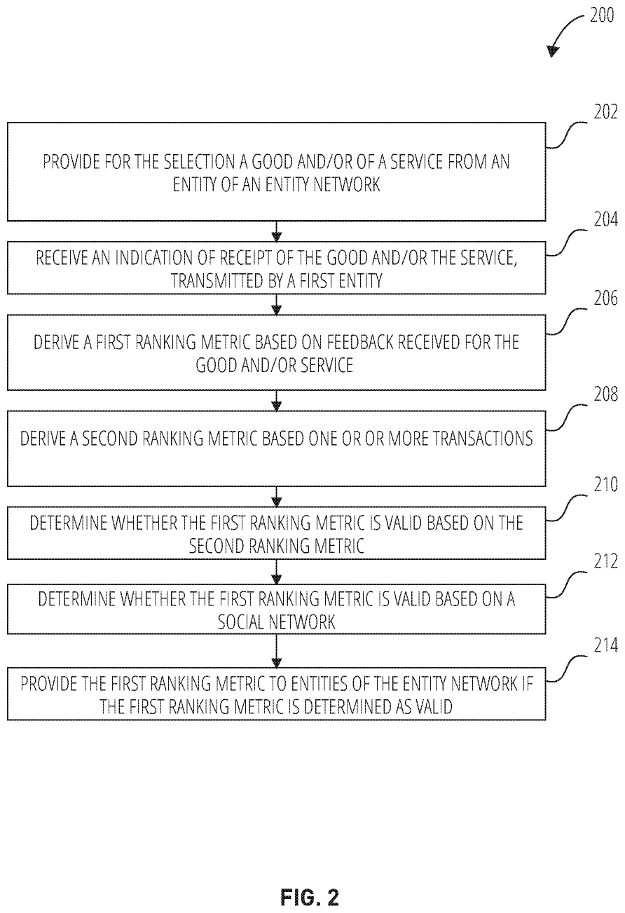

FIG. 2 is a flowchart of an embodiment of process for providing goods and/or services between entities of the entity network 100 and for ranking the entity that provided the goods and/or services, according to some examples. In the depicted embodiment, the process 200 provides, at block 202, for the selection of goods and/or services from an entity in the entity network 100. For example, a recipient entity 112, 114, 116, 118, 120 can select, via a graphical user interface (GUI), one or more goods and/or services to buy that are going to be provided by a provider entity 112, 114, 116, 118, 120 of the entity network 100. A request for delivery of the goods and/or services then occurs.

The provider entity 112, 114, 116, 118, 120 then ships the goods and/or provides the service to the recipient entity, and the process 200, at block 204, receives an indication of the receipt of the good and/or the completion of the service by the recipient entity. For example, entities 112, 114, 116, 118, 120 can receive goods via a shipment provider and the shipment provider will then automatically update certain shipment tracking numbers to reflect receipt of the goods. Likewise, once the service is provided, the provider entity will submit an invoice or another indication that the service is now completed.

The process 200 then derives, at block 206, a first ranking metric for the entity that has provided the service. For example, the receiving entity that has ordered the goods and/or service can use the ranking and monetization system 104 to leave feedback that includes a ranking metric, such as the payment metrics, the goods metrics, the services metrics, ESG metrics, and/or DEI metrics. The ranking metric includes a value range, such as a range from 1 to 10, with higher values denoting higher rankings. The process 200 also derives, at block 208, a second ranking metric for the entity that has provided the service. The second ranking metric is derived based on transactions 126, received and stored, for example, by the financial entity 112. As mentioned earlier, the financial entity 112 stores financial records such as a debit transaction and a debit timestamp from an account of the receiving entity that purchasing the goods and/or services and a corresponding credit transaction and credit timestamp from an account of the provider entity that is providing the goods and/or services.

The transaction-derived second ranking metrics thus include the timely payment metric and the complete payment metric. Transaction-derived second ranking metrics also include proof of goods and/or services delivered (e.g., via transactions such as manifests signed upon goods and/or services received) provided by the shipping and/or receiving entities. Shipping and receiving entities can also provide other proof of shipment and/or receipt, such as photographs/video of shipped and/or of received goods, useful in calculating transaction-derived timely delivery of services metrics and quality of services delivered metrics. The transactions 126 are anonymized to comply with legal and/or regulatory requirements of one or more jurisdictions where the entity network 100 may operate, for example, by removing or by obfuscating certain information.

At block 210, the process 200 determines whether the first ranking metric is valid based on the second ranking metric. For example, the first ranking metric is compared to the second ranking metric to calculate a difference value. If the difference value is inside a valid difference range (e.g., the first ranking metric is within 5% of the second ranking metric) then the process 200 determines that the first ranking metric is valid. First ranking metric values outside of the valid difference range will then be deemed as “gaming” the system. By using verifiable transaction-based ranking metrics as a baseline, the techniques described herein provide for more verifiable and accurate ranking metrics.

In some examples, social networks are also used for verification of the first ranking metric. Accordingly, the process 200, at block 212, determines if the first ranking metric is valid based on a social media network. As mentioned earlier, an entity of the entity network 100 uses social media for marketing, product sales, and the like. The entity's social media network(s) are used to create a social media graph. The social media graph includes nodes and edges, with the entity as the root or top-most node. Nodes 1 edge away from the root node are considered first level nodes directly connected to the root, e.g., to the entity. Nodes 2 edges away from the root node are connected by an order of 2, nodes 3 edges away from the root node are connected by an order of 3, and so on. Graph analysis is then performed on the nodes and edges.

For example, first level nodes can be collected and analyzed to see if the first level nodes have submitted reviews that rank the root node. Likewise, order 2, order 3, and so on, nodes can be analyzed. The median ranking value for then entity can then be compared to each node's ranking value to determine if certain nodes are submitting values that are too high. For example, ranking values in a statistical upper quartile (e.g. 4th quartile) may not be used because they are too high when compared to the median ranking value. The nodes may also be targeting competitors of the root entity and ranking them low. Accordingly, a similar graph analysis is used, comparing the nodes ranking values to a median ranking value for a competitor. Ranking values that fall into the lowest statistical quartile (e.g., 1st quartile) are then not used. It is to be noted that statistical percentages can also be used as filters for the nodes' ranking values. For example, values outside of certain statistical percentages (e.g., higher than the 85th percentile, lower than the 15th percentile) can be found as too high or too low when compared to the median ranking and not used.

The process 200 then provides, at block 214, the first ranking metric to other entities if the ranking metric is determined to be valid. For example, the ranking metric is published (e.g., via push techniques, on an online publication, and so on) so that the other entities in the entity network 100 can now see the rankings. The first ranking metric is also be used to get points or virtual currency, which can then be monetized as described earlier by purchasing goods and services, for example, if the first ranking metric exceeds a certain value (e.g., is over 7 out of 10).

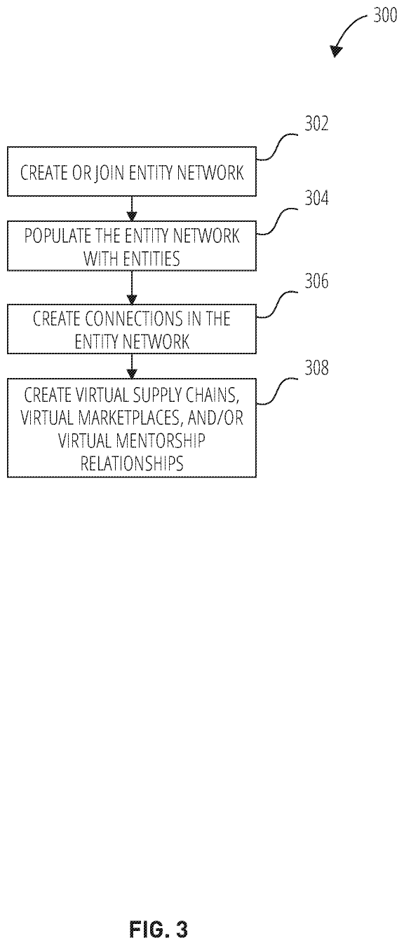

FIG. 3 is a flowchart of a process 300 for creating and using entity networks 100, according to some examples. In the depicted example, the process 300 enables a user, at block 302, to create or to join an entity network 100. The user can be an owner or an employee of an entity and is authenticated via the network entity and exchange system 102 to create and/or to join an entity network 100. For example, the user can log into a website or a mobile “app” and use the network entity and exchange system 102 to enter the name of a new entity network 100 or to search for an existing entity network 100.

The process 300, at block 302, populates the entity network 100 with one or more entities. For example, in addition to the “creator” entity that created the entity network 100, user members of the creator entity can then add other entities by selecting, for example, from a list of entities in a drop-down list of the website or mobile app, one or more entities to add at block 304. The entities selected will then automatically receive notifications (e.g., via email) to confirm that they would like to join then entity network 100.

The process 300 then, at block 306, creates connections (e.g., graph edges) in the entity network used to connect two or more entities together. For example, a graph showing all nodes and any current edges between nodes can be presented, where each node is an entity of the entity network 100 and each edge is a relationship between two entities. The user can then create a new edge between to nodes (e.g., entities) to define a new relationship. The two entities will then receive a notification to accept the new relationship (e.g., vendor relationship, supplier relationship, and so on). Various virtual supply chains, marketplaces, and/or mentorship relationships can be created at block 308. For example, a linking several supplier entities 118 via edges creates virtual relationships where a first supplier sends goods to a second supplier which then processes the goods and sends them to a third supplier, and so on. Likewise, linking several merchant entities 114 and/or service provider entities 116 creates a virtual marketplace, where the various merchant entities 114 can sell a variety of goods and/or services. Each edge includes an edge type, such as a supply chain edge, a marketplace edge, and/or a mentorship edge. Accordingly, mentorship relationships can be created by linking two or more entities via mentorship edge(s). The mentoring system 110 can then be used, as described earlier, to provide mentorship services between a mentor and a mentee.

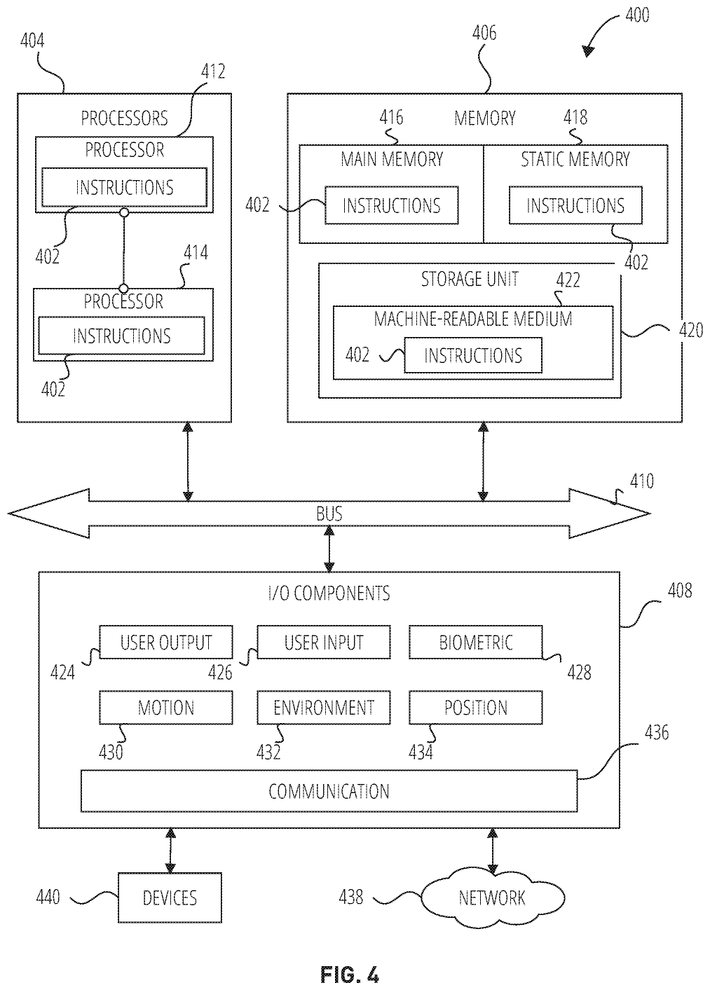

FIG. 4 is a diagrammatic representation of a machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the processes or methods described herein, such as the process 300. The instructions 402 transform the general, non-programmed machine 400 into a particular machine 400, e.g., the network entity and exchange system 102, programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 416, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 434 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 400 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-FiR components, and other communication components to provide communication via other modalities. The devices 440 may be another machine or any of a wide variety of peripheral devices (e.g., a peripheral device coupled via a universal serial bus (USB) port), internet-of-things (IoT) devices, and the like.

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

The techniques described herein provide for data communication between applications that includes using a digital distributed ledger to annotate certain data communication events and/or to record certain data transfers. By using the digital distributed ledger as further described below, the techniques described herein enable various types of applications, including disparate applications (e.g., applications that are not explicitly designed to work with each other) to transfer information between each other while a record of data transfers is maintained in an immutable and distributed manner. A data transfer chain is recorded by using data transmission records and data receipt records stored in the digital distributed ledger. The recorded data transfer chain provides an immutable and verifiable record of data transactions that have occurred for applications that participated in the chain.

What is claimed is:

1. A system comprising:
one or more hardware processors; and
at least one memory storing instructions that cause the one or more hardware processors to perform operations comprising:
receiving a selection, by a first entity, of a product, to be provided by a second entity, wherein the first entity and the second entity are members of an entity network;
receiving, via an application programming interface (API) at a server, an indication of receipt of the product, transmitted by the first entity;
deriving, at the server, a first ranking metric for the second entity of the entity network based on feedback received from the first entity of the entity network;
deriving a second ranking metric for the second entity of the entity network based on one or more transactions received from a third entity of the entity network;
determining whether the first ranking metric is valid based on the second ranking metric; and
providing, via the server, the first ranking metric to entities of the entity network based on the validity of the first ranking metric.

2. The system of claim 1, wherein the third entity of the entity network comprises a financial entity and wherein the one or more transactions comprise one or more financial transactions detailing a payment for the product, to the second entity, wherein the product comprises a good, a service, or a combination thereof.

3. The system of claim 2, wherein the one or more financial transactions comprises a credit transaction crediting a currency to an account of the second entity.

4. The system of claim 3, wherein the currency comprises one or more points accrued based on receiving a favorable ranking metric.

5. The system of claim 3, wherein the one or more financial transactions comprise a debit transaction debiting the currency to a second account of the first entity.

6. The system of claim 1, wherein determining whether the first ranking metric is valid based on the second ranking metric comprises comparing the first ranking metric to the second ranking metric to calculate a difference value, and if the difference value is inside a valid difference range, then determining that the first ranking metric is valid.

7. The system of claim 1, wherein the operations comprise determining whether the first ranking metric is valid based on a social network.

8. The system of claim 7, wherein determining whether the first ranking metric is valid based on the social network comprises determining, via graph analysis, that members of the social network have submitted ranking values lower or higher when compared to a median ranking value.

9. The system of claim 8, wherein the submitted ranking values are lower or higher if the submitted ranking values are disposed in a statistical lower quartile or in a statistical upper quartile from the median ranking value.

10. The system of claim 1, wherein the first ranking metric comprises a payment metric, a goods metric, a services metric, an environmental, social, and governance (ESG) metric, a diversity, equity, and inclusion (DEI) metric, or a combination thereof.

11. The system of claim 1, wherein the first entity comprises a grouped entity having a plurality of entity members.

12. The system of claim 11, wherein the grouped entity is organized into a virtual company.

13. The system of claim 10, wherein the product is provided by the second entity via a wholesale costing transaction.

14. The system of claim 1, wherein the operations comprise operations for creating the entity network and for populating the entity network with a plurality of entities.

15. The system of claim 1, wherein the operations comprise operations for creating a virtual supply chain, a virtual marketplace, a virtual mentorship relationship, or a combination thereof.

16. The system of claim 15, wherein the virtual supply chain, the virtual marketplace, the virtual mentorship relationship, or the combination thereof, are created by connecting two or more entities of the entity network via a graph edge, wherein the graph edge comprises a supply chain type, a virtual marketplace type, a mentorship type, or a combination thereof.

17. A machine-readable medium storing instructions that, when executed by a computer system, cause the computer system to perform operations comprising:
receiving a selection, by a first entity, of a product, to be provided by a second entity, wherein the first entity and the second entity are members of an entity network;
receiving, via an application programming interface (API) at a server, an indication of receipt of the product, transmitted by the first entity;
deriving, at the server, a first ranking metric for the second entity of the entity network based on feedback received from the first entity of the entity network;
deriving a second ranking metric for the second entity of the entity network based on one or more transactions received from a third entity of the entity network;
determining whether the first ranking metric is valid based on the second ranking metric; and
providing, via the server, the first ranking metric to entities of the entity network based on the validity of the first ranking metric.

18. The machine-readable medium of claim 17, wherein the third entity of the entity network comprises a financial entity and wherein the one or more transactions comprise one or more financial transactions detailing a payment for the product, to the second entity, wherein the product comprises a good, a service, or a combination thereof.

19. A method comprising:
receiving a selection, by a first entity, of a product, to be provided by a second entity, wherein the first entity and the second entity are members of an entity network;
receiving, via an application programming interface (API) at a server, an indication of receipt of the product, transmitted by the first entity;
deriving, at the server, a first ranking metric for the second entity of the entity network based on feedback received from the first entity of the entity network;
deriving a second ranking metric for the second entity of the entity network based on one or more transactions received from a third entity of the entity network;
determining whether the first ranking metric is valid based on the second ranking metric; and
providing, via the server, the first ranking metric to entities of the entity network based on the validity of the first ranking metric.

20. The method of claim 19, wherein the third entity of the entity network comprises a financial entity and wherein the one or more transactions comprise one or more financial transactions detailing a payment for the product, to the second entity, wherein the product comprises a good, a service, or a combination thereof.
